(19) United States
(12) Patent Application Publication
(10) Pub. No.: US 2010/0169931 A1
(43) Pub. Date: Jul. 1, 2010

(54) SYSTEM AND METHOD FOR PRESENTING SELECTED BROADCAST PROGRAMMING

(75) Inventor: Dale Mountain, West Yorkshire (GB)

Correspondence Address: INGRASSIA FISHER & LORENZ, P.C. (EchoStar), 7010 E. COCHISE ROAD, SCOTTSDALE, AZ, 85253, US

(73) Assignee: ELDON TECHNOLOGY LIMITED, Keighley (GB)

(21) Appl. No.: 12/648,789

(22) Filed: Dec. 29, 2009

(30) Foreign Application Priority Data
Dec. 29, 2008 (GB) 0823573.1

(51) Int. Cl. H04N 5/445

(52) U.S. Cl. 725/59

(57) ABSTRACT

Systems, apparatus and methods are described for presenting selected broadcast programming in response to information received from an RFID or other tag associated with a viewer. Such a system may include a television receiver, a set top box, and a user interface, such as a remote control, that enables a user to select a program to be viewed. The set top box is coupled to a detector arranged to interrogate and read personal tags identifying the individual with whom they are associated or the rights assigned to those individuals. The information obtained from the tag may be processed in any manner.

### PRIORITY CLAIM

This application claims priority to Great Britain Patent Application Number 0823573.1, which was filed on Dec. 29, 2008 and is incorporated herein by reference in its entirety.

### TECHNICAL FIELD

The following discussion relates to systems and methods for presenting selected broadcast programming.

### BACKGROUND

Set top boxes (STBs) and other television receivers are commonly used to receive broadcast programming via different types of cable, satellite, terrestrial and/or other broadcast sources. It is common to program a set top box or other television receiver using parental controls or other restrictions on the programs which may be viewed when children are present. However, if an adult, for example, wishes to watch programs that have been restricted, it is often necessary for the person to interface with the set top box by, for example, inputting a personal identification number or other password. Such access mechanisms are not foolproof, and it is sometimes possible for technically able children to find a way to circumvent some of the locks applied to a set top box. Other forms of presenting selected programming based upon the identity of the user or other information about the user may also be desired.

### BRIEF SUMMARY

Various embodiments seek different ways to control the presentation of programs using information obtained from radio frequency identification (RFID) or other tags that are associated with viewers.

Various embodiments provide a system to present broadcast programming on a presentation device. The system suitably comprises a receiver configured to receive and process the broadcast programming, a user interface configured to enable a user to select a program for presentation on the presentation device, a detector configured to receive information from a personal tag, and a control device configured to direct the presentation of the selected program on the presentation device based upon the information received from the personal tag.

Other embodiments provide a method executable by a set-top box or other television receiver for presenting selected broadcast programming. The method suitably comprises receiving the broadcast programming, receiving a user selection indicating a selected program from the broadcast programming for presentation, reading information from a personal tag associated with the user, and providing the selected program to a presentation device for presentation based upon the information from the personal tag associated with the user.

In still other embodiments, a method for restricting access to selected broadcast programming is provided. The method comprises: receiving broadcast programming, receiving a user selection indicating a selected program from the broadcast programming for presentation, reading information from a personal tag associated with the user, and providing the selected program for presentation on the presentation device if the information from the personal tag indicates that the user is authorized to view the selected program.

### BRIEF DESCRIPTION OF THE DRAWING

The present invention is now described, by way of example, with reference to the accompanying drawing in which

FIG. 1 shows schematically an exemplary receiver for presenting selected broadcast programming together with individuals in proximity to that receiver; and

FIG. 2 shows a flowchart of an exemplary method of providing programming based upon information received from one or more personal tags.

Various embodiments, aspects and other features are described in more detail below.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The following discussion frequently considers the control of a set top box for a television receiver. A “set top box” may be understood to comprehend a digital device able to impart functionality to the television receiver whether provided in a stand alone box, incorporated in a stand alone box along with other devices, or integrated within the television receiver. Various embodiments are therefore frequently described below specifically with reference to that context. However, various other embodiments as described herein can be utilized to control electronic devices other than set top boxes for television receivers. For example, various embodiments may be used to provide control by an authorized user of an audio device, or computer, or other electronic device.

The specification also refers to a presentation device. This might be the display and loud speakers incorporated within a television receiver. Alternatively, the display might be provided separately as a monitor, for example, or might be provided by an electronic device such as a computer. Similarly, the loud speakers may be provided within a television receiver or separately or by some other electronic device.

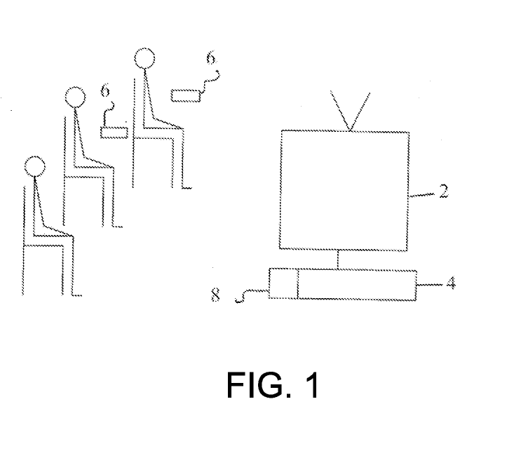

As is shown in FIG. 1, a television receiver 2 is provided to receive and present broadcast programming. The television receiver 2 is coupled to a set top box 4 which is able to tune to selected channels or programs within received broadcast transmissions, to decompress, decode and otherwise process the selected programs as necessary, and to cause them to be displayed by the television receiver 2. It will be appreciated that the technology to display audio or visual content by way of a television receiver 2 and a set top box 4 as illustrated is well known and accordingly no further explanation thereof is necessary. The set top box 4 may be programmed, for example, to include various channel, rating or parental locks, and thus to control the programs to be 5 presented as required. Normal programming of the set top box 4 to set controls and locks will be by way of a remote control device (not shown) in the normal manner. Similarly, the remote control device will provide the user interface enabling a user to select programs for viewing, and then to command the set top box to cause the selected program to be presented on the TV receiver.

When controls have been set on a set top box, for example, to prevent access to adult programming, the set top box controls have to be overridden to enable access to the programming by communicating with the set top box. This may mean, for example, that an adult has to input a pin number or other password, by way of the remote control unit, in order to get access to films and other programming.

Various embodiments provide members of the household, for example, with a personal tag or card 6 which defines the viewing rights that each person has. The tag 6 also informs the set top box 4 of those rights so that intervention by the viewer to access programming, for example, by inputting a pin, is not required. In this way, the features of the set top box are available by user and not centrally at the box.

One or more users in the household may be provided with a personal tag 6. This might be the size and configuration, for example, of a credit card so that it is readily portable. Alternatively, the tag might be formed as a bracelet or brooch, or as a key ring or other object which is frequently carried or worn by a person. The tag 6 incorporates an RFID tag. The set top box 4 incorporates or is coupled to an RFID detector 8. Thus, when the remote control device is actuated to energize the set top box 4 and to select a channel, the RFID detector 8 may be able to interrogate any tags 6 in the vicinity. By this interrogation, the detector 8 establishes the identity, status or access rights of the individuals carrying the tags within the vicinity. With this information the detector 8 is enabled to prevent access to specific programming, and/or to enable such access. RFID detectors and passive and active tags able to respond to such detectors are known to those skilled in the art, such that further explanation of RFID technology is not required.

For example, the parents of a household can each be provided with tags 6 enabling access to all channels irrespective of ratings. However, the tags 6 assigned to children can prevent access to adult programming and other types or categories of programs deemed unsuitable. If there are no tags 6 in the vicinity not only can access to adult programming, for example, be prevented but access to pay per view programming may also be prevented. In the situation where there are no proximate tags, access to recordings on the set top box, and access to make or to delete recordings may be denied. Many different functions based upon information contained on the tag and/or the identities of the persons in proximity to the receiver may be formulated.

In use, users with access to a particular system (the individuals in a household, for example) may each be provided with a personal tag carrying information about their identity and/or about their access privileges. A personal tag may simply identify an individual as a child or adult, for example, or it may include information as to types of broadcasts each individual is allowed to access. In one example, children may be denied access to adult programming, and it may be only an adult or an individual who pays the programming bill that is allowed access to gaming programming, shopping channels, on-demand content and/or other programming as desired.

The control device is caused, when a program selection is made by way of the user interface, to interrogate and read any personal tags in the vicinity. If this interrogation process reveals no adult tags, for example, presentation of a selected adult program may be prevented. The control device may be caused to interrogate any personal tags whenever a program selection is made. Alternatively, the control device may be caused to interrogate personal tags for the required information only when programs of types or categories to be controlled are selected.

In an exemplary embodiment, each personal tag is an inductive tag which may be passive (i.e., non-powered) or active (i.e., powered). The personal tag carries information identifying the individual to whom the tag has been issued, and/or identifying one or more types or categories of programs to which the individual may have access, and/or identifying one or more types or categories of programs to which the individual may not have access. The control device or detector used to read the tag comprises an inductive detector able to transmit interrogatory commands and to receive and process the responses from interrogated inductive tags. Other embodiments may use other types of tags and/or readers as desired. In various exemplary embodiments, the personal tags are radio frequency identification (RFID) tags, and the detector or controller used to read information from the tags comprises an RFID detector/reader.

For convenience, each personal tag may be incorporated in a card, such as a personal viewing card, that may be easily carried about the person. Additionally, and/or alternatively, one or more tags may be incorporated in items of personal ornament, such as a bracelet or brooch, or in personal items such as a wallet or key ring, frequently carried or worn by a person.

In various embodiments, the receiver comprises a processor or other processing means arranged to process the received broadcast programming as is required to enable the presentation of the selected program. The processing means may be implemented as a set top box or other digital signal processing device coupled to, or incorporated in, a television receiver. The processing device decompresses and decodes arriving broadcast programming as necessary, tunes to the program selected by way of the user interface, and undertakes any necessary further signal processing to appropriately provide the selected program to the presentation device.

The presentation device or other presenting means comprises a display or monitor, and preferably one or more loudspeakers, to display video content, and to present the sound associated with video content or to present audio programs. Examples of presentations devices could include televisions, displays and/or the like.

The user interface preferably comprises a remote control unit or other device capable of receiving user inputs for selecting programs for viewing and/or performing other tasks as desired.

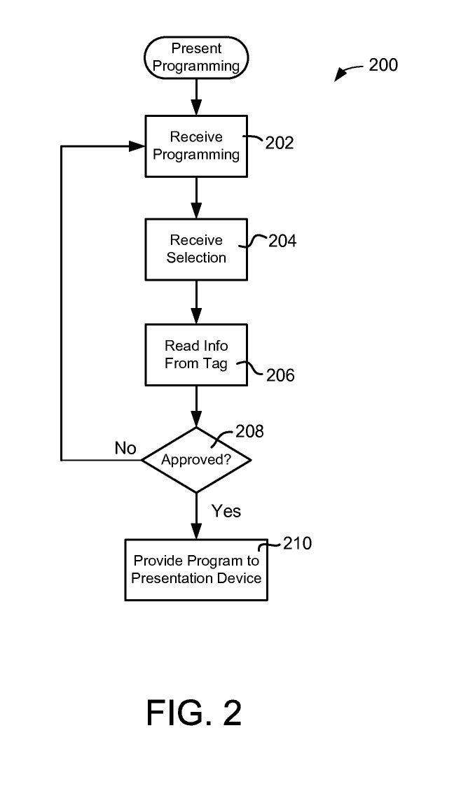

Referring now to FIG. 2, various embodiments provide a method 200 for presenting selected broadcast programming based upon information received on an RFID or other personal tag associated with a viewing user. As shown in FIG. 2, the method suitably comprises receiving broadcast programming (function 202), selecting a program from the broadcast programming for presentation in dependence upon user selection (function 204), interrogating and/or otherwise reading any personal tags in the vicinity (function 206), checking the information read from the personal tags to determine if the programming is authorized, or otherwise appropriate, in view of the information obtained from the personal tag (function 208), and providing that selected program to a presentation device for presentation (function 210). These basic functions may be executed in any order, and/or may be supplemented or modified in any manner.

In some embodiments, the information obtained from the personal tag simply identifies one or more users in proximity to the reader. In other embodiments, each personal tag may carry information about the identity and/or about access privileges of an individual to whom the tag is provided. For example, each personal tag may identify an individual as a child or adult, or it may include information as to types of broadcasts or other programming that each individual is allowed to access. Such information may affirmatively list programs (or types of programs) that the person is permitted to view, and/or programs (or types of programs) that the person is not permitted to view.

Method 200 may suitably comprises interrogating or otherwise reading any personal tags in the vicinity in response to the user selection of a program. The presentation of the selected program may be restricted or otherwise provided based upon the information obtained from the personal tag(s) in any manner. The method may involve interrogating any personal tags whenever there is user selection of a program. If this interrogation process reveals no tags identifying an adult, for example, presentation of any adult or other programming may be prevented. Alternatively, personal tags may be interrogated for the required information only when programs of types or categories to be controlled have been selected.

In some embodiments, each personal tag is a passive, non-powered inductive tag carrying information identifying the individual to whom the tag has been issued, and/or identifying types or categories of programs to which the individual may have access. The interrogation and reading of the personal tags comprises causing an inductive detector to transmit interrogatory commands, and to receive and to process responses to the interrogatory commands from interrogated inductive tags.

The types or categories of programs to which methods of the invention control access may include, without limitation, adult programming, on-demand programming, pay-per-view programming, gaming, shopping channels, interactive and chatroom services, dating services, gay content, and/or other specialized content. Any other types of programming may be provided or restricted based upon information obtained from RFID or other personal tags as desired.

In an exemplary embodiment, the method further comprises processing the received broadcast programming to enable the presentation of the selected program. The processing may include decompressing and decoding arriving broadcast programming as desired, tuning to the user selected program, and undertaking any further signal processing to appropriately provide the selected program for presentation. The program presented may comprise video content, with associated sound, if provided, or the program may be an audio program.

Various embodiments may use one or more personal tags for use in controlling the presentation of selected broadcast programming by way of a receiving device, the personal tag being arranged to be convenient for an individual to carry, and the personal tag incorporating an inductive tag carrying information identifying the individual to whom the tag is issued, the inductive tag being arranged to respond to interrogatory commands from the receiver, the response including the identifying information relating to the individual and causing the receiver to control presentation of the selected program in accordance with the identity of the individual.

Various systems, devices and techniques have been described. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

The term “exemplary” is used herein to represent one example, instance or illustration that may have any number of alternates. Any implementation described herein as exemplary is not necessarily to be construed as preferred or advantageous over other implementations.

It will be appreciated that variations to, and modifications of, the embodiment as described may be made within the scope of this invention as defined in the accompanying claims.

1. A system to present broadcast programming on a presentation device, the system comprising:
a receiver configured to receive and process the broadcast programming;
a user interface configured to enable a user to select a program for presentation on the presentation device;
a detector configured to receive information from a personal tag; and
a control device configured to direct the presentation of the selected program on the presentation device based upon the information received from the personal tag.

2. The system of claim 1, wherein the control device is configured to direct the detector to interrogate the personal tag for the information whenever a program selection is made by way of the user interface.

3. The system of claim 1, wherein the control device is configured to direct the detector to interrogate the personal tag for the required information only when programs of types or categories to be controlled are selected.

4. The system of claim 1, wherein the personal tag is a passive, non-powered inductive tag.

5. The system of claim 1, wherein the personal tag is an inductive tag.

6. The system of claim 5, wherein the detector comprises an inductive detector configured to transmit interrogatory commands to the inductive tag and to receive and process a response from inductive tag.

7. The system of claim 1, wherein the personal tag is a RFID tag, and wherein the detector comprises a RFID detector.

8. The system of claim 1, wherein the personal tag is incorporated in one of the group consisting of: a card that is configured to be carried by the user, an item of personal ornament, and a personal object configured to be carried or worn by the user.

9. The system of claim 1 wherein the control device is configured to prevent the presentation of the selected program on the presentation device based upon the information received from the personal tag.

10. The system of claim 1 wherein the control device is configured to allow the presentation of the selected program on the presentation device based upon the information received from the personal tag.

11. A method for presenting selected broadcast programming, the method comprising:
receiving the broadcast programming;
receiving a user selection indicating a selected program from the broadcast programming for presentation;
reading information from a personal tag associated with the user; and
providing the selected program to a presentation device for presentation based upon the information from the personal tag associated with the user.

12. The method of claim 11, wherein the reading comprises interrogating the personal tag in response to the user selection.

13. The method of claim 11, wherein the reading comprises interrogating the personal tag only when the selected program is of a particular type or category.

14. The method of claim 11 wherein the providing comprises preventing the presentation of the selected program on the presentation device based upon the information received from the personal tag.

15. The method of claim 11 wherein the providing comprises allowing the presentation of the selected program on the presentation device based upon the information received from the personal tag.

16. The method of claim 11 wherein the personal tag is an inductive tag, and wherein the reading comprises transmitting interrogatory commands to the inductive tag and receiving a response from inductive tag.

17. The method of claim 11 wherein the personal tag is a RFID tag.

18. A method for restricting access to selected broadcast programming, the method comprising:
receiving broadcast programming;
receiving a user selection indicating a selected program from the broadcast programming for presentation;
reading information from a personal tag associated with the user; and
providing the selected program for presentation on the presentation device if the information from the personal tag indicates that the user is authorized to view the selected program.

19. The method of claim 18 wherein the personal tag is an inductive tag, and wherein the reading comprises transmitting interrogatory commands to the inductive tag and receiving a response from inductive tag.

20. The method of claim 18 wherein the personal tag is a RFID tag.
